(19) United States
(12) Patent Application Publication
(10) Pub. No.: US 2026/0087546 A1
(43) Pub. Date: Mar. 26, 2026

(54) ONLINE AUCTION PLATFORMS AND METHODS OF OPERATING THE SAME TO FACILITATE PROSPECTIVE BUYER PAID MEMBERSHIPS OR SUBSCRIPTIONS

(71) Applicant: Liboly, LLC, Indianapolis, IN (US)

(72) Inventor: Mark Christopher Reichel, Indianapolis, IN (US)

(73) Assignee: Liboly, LLC, Indianapolis, IN (US)

(21) Appl. No.: 19/408,535

(22) Filed: Dec. 4, 2025

Related U.S. Application Data
(60) Provisional application No. 63/728,273, filed on Dec. 5, 2024.

(51) Int. Cl. G06Q 30/08

(52) U.S. Cl. CPC G06Q 30/08

(57) ABSTRACT

Online auction platforms and methods of operating the same to facilitate prospective buyer paid memberships or subscriptions. In one method of operating an online auction platform, the method includes the steps of receiving an auction listing listed at a recorded time for a product including an initial auction bid price and a direct purchase price, determining, by one or more network connected servers, a release time for the auction listing for non-subscribing users based on the recorded time and a time delay parameter, first displaying the auction listing to a subscribing user of the online auction platform prior to the auction listing being available to a non-subscribing user of the online auction platform, and second displaying the auction listing to a non-subscribing user of the online auction platform after a predetermined time has elapsed between the recorded time and a then-current server time or on or after the release time.

### PRIORITY AND RELATED APPLICATION

The present U.S. nonprovisional patent application is related to, and claims the priority benefit of, U.S. Provisional Patent Application Serial No. 63/728,273, filed December 5, 2024, the contents of which are incorporated herein directly and by reference in their entirety.

### TECHNICAL FIELD

The present disclosure relates generally to online auction systems (electronic commerce auction platforms). More particularly, it relates to computer-implemented systems and methods for controlling user access to auction listings based on membership level, subscription status, or tiered participation, thereby providing paid members or subscribers with prioritized, time-gated access to listings or purchase opportunities.

### BACKGROUND

Online auction companies, such as eBay, facilitate listings of goods that can be offered as absolute auctions, auctions with minimum price reserves, and listings with “buy-it-now” (direct purchase) prices. Said auction listings can be sorted by those ending soonest, those with high or low bid prices, and those that are most newly listed. Conventional auction systems allow all users to view newly listed items at the same time, which results in intense competition for high-demand goods and provides no mechanism for prioritizing loyal users. Existing systems/platforms lack a structured method to monetize early access to listings, leaving potential revenue streams untapped.

In at least one scenario, eBay can facilitate a listing of goods for sale whereby the listing includes a “buy-it-now” (direct purchase) price, and whereby a prospective buyer can search keywords in connection with said listing, and further sort resultant listings by those that are most newly listed. It is noted that existing online auctions do not provide mechanisms for prioritized access to said listings, leading to a competitive disadvantage for traditional users.

While some e-commerce websites and apps, such as Amazon Prime or ticketing systems, provide members early or exclusive access to sales, these models do not apply to single-instance online auctions, including those having an initial auction price and a buy-it-now (direct purchase) price in connection with said goods. Thus, a need exists for an online auction platform that introduces tiered or time-gated listing visibility based on user membership or subscription level, implemented via computerized control logic, thereby rewarding paid users while maintaining auction fairness.

It is noted that eBay, for example, was founded in 1995, namely thirty (30) years ago. eBay’s annual revenue for 2024 was $10.28 billion dollars. As such, eBay enjoys unprecedented success in the online auction space, and it is noted that even companies like eBay do not offer the early access subscription mechanism as noted herein.

Given eBay’s long-standing success and the prevalence of paid membership systems across e-commerce, it is notable that no online auction platform has implemented server-level, time-indexed visibility gating. This absence, despite the financial incentives, demonstrates that the present invention provides a non-obvious technical combination that was neither routine nor predictable to one of ordinary skill in the art. Should it have been obvious to incorporate such a mechanism as disclosed herein in further detail, companies like eBay surely would have taken advantage of it by now.

It is further noted that eBay has no timing differentiation or membership-tier access control, while the present disclosure, for example, can computationally gate listing availability by time offset per membership or subscription tier. At the present time, eBay publishes all listings simultaneously and lacks automated access control tied to user tier metadata. Conventional auction platforms like eBay disclose concurrent listing visibility rather than tier-differentiated access logic executed by its server. eBay’s server returns all new listings in query responses without performing tier-based or time-dependent query exclusion. The absence of such features in mature platforms indicates that the disclosed combination of auction and algorithmic time-gating was not routine, predictable, or obvious to one of ordinary skill in the art.

Despite decades of competition and numerous membership innovations across e-commerce, no online auction platform is known to implement automated, tier-based listing visibility or time-delayed access logic.

Furthermore, Amazon Prime, as noted above, utilizes “Lightning Deals,” whereby Amazon Prime members obtain early access to multi-item deals. This substantively differs from the systems and methods of the present disclosure as Amazon uses retail sales of identical SKUs, not unique, single-instance auctions, and Amazon itself does not do auctions, so therefore there are no initial auction prices and buy-it-now (direct purchase) prices in connection with the same goods. Amazon focuses on multi-unit retail, not single-instance auctions, and focuses on “advertised pre-release” versus unannounced, algorithmic release. Amazon’s early access mechanisms operate via promotional tagging, not algorithmic gating of database query visibility. The present auction-based mechanism is unique in this regard and utilizes individual listing visibility control.

Companies like Ticketmaster, Nike SNKRS, Event Brite, and various airline systems also provide early access for paying members or verified users. However, these are reservations or ticket queues, not auction environments, and therefore they do not have initial auction prices and buy-it-now (direct purchase) prices in connection with the same goods. In systems of the present disclosure, the auction itself and listing exposure can be algorithmically time-gated, whereas Ticketmaster and other systems use queue-based inventory allocation and not database query restriction.

It is noted that systems and methods herein control buyer access, not seller ranking. It therefore focuses on user visibility logic, not promotional listing logic.

### BRIEF SUMMARY

The present disclosure includes disclosure of an online auction platform, as described herein. In particular, a time-based access differentiation mechanism that monetizes early listing visibility for paying members – thus generating a new revenue stream for the platform itself and providing competitive advantages to said members – is disclosed herein.

The present disclosure includes disclosure of an online auction platform offering a paid membership or subscription model providing the ability of paid members or paid subscribers to access at least some auction listings sooner than those prospective buyers who are not paid members or paid subscribers.

The disclosed systems and methods improve the functioning of online auction servers by, for example, implementing asynchronous, membership-tier–based query filtering that distributes network load, reduces simultaneous access contention, and enhances database throughput. Unlike conventional e-commerce systems, which respond to user queries by returning all active listings, the present system can dynamically gate query results according to time and membership metadata, thereby improving computational efficiency and reducing latency.

The present disclosure provides systems and methods for operating an online auction platform that differentiates user access to listings based on membership level or subscription tier. Paid members or subscribers are granted earlier access to certain listings, such as fixed-price ('buy-it-now') items, before those listings become visible to non-paying users. The invention introduces a time-gated access mechanism that operates automatically through the platform’s server, such as by way of using timestamps, membership databases or modules, and controlled query responses. This creates new monetization models for the platform operator while providing tangible benefits to paying members.

The present disclosure includes disclosure of an online auction platform, comprising facilitating a paid membership or paid subscription with a prospective buyer so that said prospective buyer is a paid member or a paid subscriber once the prospective buyer has paid a membership fee or subscription fee, and wherein the prospective buyer thereafter has the ability to search for and identify at least some auction listings sooner than other prospective buyers who are not paid members or paid subscribers.

The present disclosure includes disclosure of an online auction platform, further comprising facilitating the searching for and identification of at least one auction listing by the prospective buyer on the online auction platform, the at least one auction listing offering the ability for the prospective buyer to purchase the item in the at least one auction listing outright without being required to bid on the item in the at least one auction listing.

The present disclosure includes disclosure of an online auction platform, whereby the identification of the at least one auction listing is performed by the prospective buyer before it could have been performed by other prospective buyers who are not paid members or paid subscribers.

The present disclosure includes disclosure of an online auction platform, further comprising facilitating the sale of the item in the at least one auction listing by the prospective buyer before other prospective buyers who are not paid members or paid subscribers would have been able to identify the auction listing.

The present disclosure includes disclosure of an online auction platform, further comprising facilitating the receipt of payment for the item by the prospective buyer.

The present disclosure includes disclosure of an online auction platform, provided to generate revenue and potential additional profit to the online auction platform via paid membership or paid subscription fees.

The present disclosure includes disclosure of a method of operating an online auction platform, comprising the steps of receiving an auction listing listed at a recorded time for a product including an initial auction bid price and a direct purchase price, determining, by one or more network connected servers, a release time for the auction listing for non-subscribing users based on the recorded time and a time delay parameter, and first displaying the auction listing to a subscribing user of the online auction platform prior to the auction listing being available to a non-subscribing user of the online auction platform, such as on or after the release time.

The present disclosure includes disclosure of a method of operating an online auction platform, wherein providing access to the auction listing to the non-subscribing user comprises, prior to transmitting query results to a user device, executing a server-side query filter that excludes auction listings whose release time for the non-subscribing user has not yet expired

The present disclosure includes disclosure of a method of operating an online auction platform, further comprising the step of second displaying the auction listing to a non-subscribing user of the online auction platform after a predetermined time has elapsed between the recorded time and a then-current server time.

The present disclosure includes disclosure of a method of operating an online auction platform, further comprising the step second displaying the auction listing to a non-subscribing user of the online auction platform a) after a predetermined time has elapsed between the recorded time and a then-current server time, or b) at or after the release time.

The present disclosure includes disclosure of a method of operating an online auction platform, wherein the steps of receiving, first displaying, and/or second displaying are performed using one or more network-connected servers.

The present disclosure includes disclosure of a method of operating an online auction platform, further comprising the step of comparing the recorded time to a then-current server time to determine whether or not a user of the online auction platform has access to the auction listing at the then-current server time, said step of comparing performed prior to the step of first displaying.

The present disclosure includes disclosure of a method of operating an online auction platform, wherein the subscribing user has access to the auction listing and any other auction listing within the online auction platform at any time.

The present disclosure includes disclosure of a method of operating an online auction platform, wherein the subscribing user has a membership or subscription tier associated therewith, the membership or subscription tier selected from a first membership or subscription level and a second membership or subscription level different than the first membership or subscription level.

The present disclosure includes disclosure of a method of operating an online auction platform, wherein the first membership or subscription level provides the subscribing user with earlier access to the auction listing than the second membership or subscription level would provide.

The present disclosure includes disclosure of a method of operating an online auction platform, wherein the step of first displaying is performed to display the auction listing on a screen of an electronic device.

The present disclosure includes disclosure of a method of operating an online auction platform, wherein the auction listing is displayed to the subscribing user after determining that a membership or subscription status identifies the subscribing user as a subscribing user.

The present disclosure includes disclosure of a method of operating an online auction platform, wherein the auction listing is displayed to a subscribing user after the subscribing user is authenticated by logging into the online auction platform.

The present disclosure includes disclosure of a method of operating an online auction platform, wherein the auction listing is only displayed to a non-subscribing user after the non-subscribing user is logged into the online auction platform and only after a predetermined time has elapsed between the recorded time and a then-current server time.

The present disclosure includes disclosure of a method of operating an online auction platform, wherein a user of the online auction platform becomes a subscribing user after payment of a fee associated with a subscription to the online auction platform.

The present disclosure includes disclosure of a method of operating an online auction platform, wherein a subscribing user of the online auction platform can view the auction listing and purchase the product associated with the auction listing before non-subscribing users of the online auction platform can view the auction listing.

The present disclosure includes disclosure of a method of operating an online auction platform, wherein membership or subscription statuses of users of the online auction platform comprise tier levels stored in a membership database (such as a subscription management module), each tier level being associated with a respective release time delay, and wherein the server automatically delays display of the first auction listing to users of lower-tier membership or subscription levels until expiration of the release time delay applicable to those tiers.

The present disclosure includes disclosure of a method of operating an online auction platform, wherein the one or more network-connected servers are configured to execute an access-control algorithm that improves computational efficiency by distributing listing query execution across membership or subscription tiers to reduce concurrent database load.

The present disclosure includes disclosure of a computer-implemented method of operating an online auction platform, comprising the steps of receiving an auction listing listed at a recorded time for a product including an initial auction bid price and a direct purchase price, first displaying the auction listing to a subscribing user of the online auction platform prior to the auction listing being available to a non-subscribing user of the online auction platform, and second displaying the auction listing to a non-subscribing user of the online auction platform after a predetermined time has elapsed between the recorded time and a then-current server time, wherein each step is performed using one or more network-connected servers.

The present disclosure includes disclosure of a computer-implemented method of operating an online auction platform, wherein the subscribing user has a membership or subscription tier associated therewith, the membership or subscription tier selected from a first membership or subscription level and a second membership or subscription level different than the first membership or subscription level.

The present disclosure includes disclosure of a computer-implemented method of operating an online auction platform, wherein the first membership or subscription level provides the subscribing user with earlier access to the auction listing than the second membership or subscription level would provide.

The present disclosure includes disclosure of a computer-implemented method of operating an online auction platform, wherein the auction listing is only displayed to a non-subscribing user after the non-subscribing user is logged into the online auction platform and only after a predetermined time has elapsed between the recorded time and a then-current server time.

The present disclosure includes disclosure of a computer-implemented method of operating an online auction platform, wherein a subscribing user of the online auction platform can view the auction listing and purchase the product associated with the auction listing before non-subscribing users of the online auction platform can view the auction listing.

The present disclosure includes disclosure of a method of operating an online auction platform, comprising by a network-connected server, computing a time-based release parameter for each listing based on membership or subscription tier metadata stored in a membership database (such as a subscription management module), facilitating a paid membership or paid subscription with a prospective buyer so that said prospective buyer is a paid member or a paid subscriber once the prospective buyer has paid a membership fee or subscription fee, and wherein the prospective buyer thereafter has the ability to search for and identify at least some auction listings sooner than other prospective buyers who are not paid members or paid subscribers, and transmitting, by the server, a filtered query result set to the client device comprising only listings authorized for the user’s membership or subscription tier.

The present disclosure includes disclosure of a method of operating an online auction platform, further comprising facilitating the searching for and identification of at least one auction listing by the prospective buyer on the online auction platform, the at least one auction listing offering the ability for the prospective buyer to purchase the item in the at least one auction listing outright without being required to bid on the item in the at least one auction listing.

The present disclosure includes disclosure of a method of operating an online auction platform, whereby the identification of the at least one auction listing is performed by the prospective buyer before it could have been performed by other prospective buyers who are not paid members or paid subscribers.

The present disclosure includes disclosure of a method of operating an online auction platform, further comprising facilitating the sale of the item in the at least one auction listing by the prospective buyer before other prospective buyers who are not paid members or paid subscribers would have been able to identify the auction listing.

The present disclosure includes disclosure of a method of operating an online auction platform, further comprising facilitating the receipt of payment for the item by the prospective buyer.

The present disclosure includes disclosure of a method of operating an online auction platform, provided to generate revenue and potential additional profit to the online auction platform via paid membership or paid subscription fees.

The present disclosure includes disclosure of a method of operating an online auction platform, operable using a server, and further comprising receiving, at a server, an auction listing having a posting timestamp, associating the auction listing with a time-based access control parameter, determining a membership or subscription level of a user, determining a release time for the listing based on the membership or subscription level, controlling access such that the listing becomes visible to the user only after the release time, and permitting the user to purchase the item using a buy-it-now (direct purchase) option prior to access by lower-tier users.

The present disclosure includes disclosure of a method of operating an online auction platform, wherein the access control parameter defines a delay period associated with each membership or subscription tier.

The present disclosure includes disclosure of a method of operating an online auction platform, further comprising authenticating the user via a membership database (such as a subscription management module) prior to providing access to listings.

The present disclosure includes disclosure of a method of operating an online auction platform, wherein the server executes a search query that returns only listings having expired access windows for the user's membership or subscription tier.

The present disclosure includes disclosure of a method of operating an online auction platform, wherein notifications are generated when a listing becomes available to a user’s tier.

The present disclosure includes disclosure of a system for operating an online auction platform, comprising a network-connected server configured to host an auction database storing listings, timestamps, and access control data, a membership database (such as a subscription management module) storing user information and membership or subscription tiers, and a control module configured to restrict or grant listing visibility based on membership or subscription tier and time delay parameters.

The present disclosure includes disclosure of a system for operating an online auction platform, wherein the control module applies authentication and anti-bot verification protocols to ensure fair access.

The present disclosure includes disclosure of a system for operating an online auction platform, wherein the server is configured to log access events and purchase activity by membership or subscription tier for analytics and audit.

The present disclosure includes disclosure of a system for operating an online auction platform, wherein the control module provides tier-based countdown indicators within a graphical user interface.

The present disclosure includes disclosure of a system for operating an online auction platform, wherein the control module executes a tier-specific query scheduler that staggers listing index updates by membership or subscription level.

The present disclosure includes disclosure of a system for operating an online auction platform, wherein the control module is further configured to dynamically adjust the access delay parameter in response to detected network load.”

The present disclosure includes disclosure of a mechanism for an online auction platform to generate revenue, comprising implementing an embodiment of the present disclosure to generate revenue from paid members or paid subscribers who wish to have early access to at least some auction listings.

The present disclosure includes disclosure of a method for operating an online auction platform, wherein the first auction listing is displayed to a subscribing member user regardless of the timestamp.

The present disclosure includes disclosure of a method of operating an online auction platform configured to receive and display auction listings for products also having a direct purchase price using a network-connected server executing an access-control algorithm, the method comprising receiving a first auction listing for a product including a first direct purchase price, assigning a timestamp to the first auction listing, and selectively displaying the first auction listing to users of the online auction platform based upon membership or subscription statuses of said users.

The present disclosure includes disclosure of a computer-implemented method of operating an online auction platform, comprising, receiving, by a network-connected server, an auction listing for a product including a direct purchase price, assigning, by the server, a timestamp to the listing, determining, based on membership-tier metadata stored in a membership database (such as a subscription management module), a release time for the listing, automatically filtering, by an access-control module executing on the server, query results to exclude listings for which the current time is earlier than the release time for a requesting user’s membership or subscription tier, and transmitting, by the server, a filtered result set for display on a user device, thereby allowing higher-tier subscribing members to view and purchase listings before lower-tier or non-subscribing users.

The present disclosure includes disclosure of a computer-implemented method of operating an online auction platform, comprising receiving, using one or more network-connected servers, a first auction listing for a product including an initial auction bid price and a direct purchase price, assigning, by one or more servers of the one or more network-connected servers, the server, a timestamp to the first auction listing, and automatically displaying, by one or more server of the one or more network-connected servers executing an access-control algorithm, the first auction listing to users of the online auction platform based on membership or subscription statuses of the users, each user having an associated membership or subscription status indicating whether the user is a subscribing or non-subscribing member, and a comparison between the timestamp and a current server time, thereby enabling a subscribing member to view the first auction listing and purchase the product at the direct purchase price prior to a non-subscribing member having access to said first auction listing.

The present disclosure includes disclosure of a computer-implemented method of operating an online auction platform, wherein the online auction platform is hosted on and operated using the server, and wherein the steps of receiving, assigning, and automatically displaying are performed using one or more algorithms executed by the server, and wherein automatically displaying comprises selectively displaying the first auction listing on a screen of an electronic device.

The present disclosure includes disclosure of a computer-implemented method of operating an online auction platform, wherein the server compares the timestamp to a current server time and delays display of the first auction listing to non-subscribing users by a time period associated with a membership or subscription tier.

The present disclosure includes disclosure of a computer-implemented method of operating an online auction platform, wherein the first auction listing is displayed to a user after determining that the membership or subscription status of the user identifies the user as a subscribing member.

The present disclosure includes disclosure of a computer-implemented method of operating an online auction platform, wherein the first auction listing is not displayed to a user until after determining that the membership or subscription status of the user identifies the user as a non-subscribing member and after a time delay determined by comparing the timestamp to the current server time.

The present disclosure includes disclosure of a computer-implemented method of operating an online auction platform, wherein the first auction listing is displayed to a subscribing member user after the subscribing member user is authenticated by logging into the online auction platform.

The present disclosure includes disclosure of a computer-implemented method of operating an online auction platform, wherein the first auction listing is displayed to a non-subscribing user after the non-subscribing user is logged into the online auction platform, and only after expiration of a specified time period determined by comparing the timestamp to the current server time.

The present disclosure includes disclosure of a computer-implemented method of operating an online auction platform, wherein the membership or subscription status of each user is determined based on whether the user is a subscribing member of the online auction platform.

The present disclosure includes disclosure of a computer-implemented method of operating an online auction platform, wherein a user of the online auction platform becomes a subscribing member after payment of a fee associated with a subscription to the platform.

The present disclosure includes disclosure of a computer-implemented method of operating an online auction platform, wherein determining the membership or subscription status of a user comprises verifying, by the server, that the user has paid an active subscription fee recorded in a membership database (such as a subscription management module), and wherein access to the first auction listing is granted only after confirmation of the paid subscription status.

The present disclosure includes disclosure of a computer-implemented method of operating an online auction platform, wherein a subscribing member user of the online auction platform can view the auction listing and purchase the product associated with the first auction listing before non-subscribing member users of the online auction platform can view the auction listing.

The present disclosure includes disclosure of a computer-implemented method of operating an online auction platform, wherein the membership or subscription statuses of the users comprise tier levels stored in a membership database (such as a subscription management module), each tier level being associated with a respective release time delay, and wherein the server automatically delays display of the first auction listing to users of lower-tier membership or subscription levels until expiration of the release time delay applicable to those tiers.

The present disclosure includes disclosure of a computer-implemented method of operating an online auction platform, wherein the access-control algorithm improves computational efficiency by distributing listing query execution across membership or subscription tiers to reduce concurrent database load.

The present disclosure includes disclosure of a computer-implemented method of operating an online auction platform, wherein the server dynamically adjusts release time delays based on detected network load or listing popularity metrics.

The present disclosure includes disclosure of a computer-implemented method of operating an online auction platform, comprising receiving, by a network-connected server, a first auction listing for a product including a direct purchase price, assigning, by the server, a timestamp to the first auction listing, and automatically displaying, by the server executing an access-control algorithm, the first auction listing to users of the online auction platform based on their membership or subscription status and a comparison between the timestamp and a current server time, thereby enabling a subscribing member to view the first auction listing and purchase the product prior to a non-subscribing member, wherein the membership or subscription status provides for at least one level of early access to said first auction listing.

The present disclosure includes disclosure of a computer-implemented method of operating an online auction platform, wherein the access-control algorithm filters auction listings prior to execution of a search query by excluding listings having release times later than the current server time for a given membership or subscription tier.

The present disclosure includes disclosure of a computer-implemented method of operating an online auction platform, wherein the access-control algorithm improves query efficiency by automatically filtering results to exclude listings for which the release time has not yet elapsed for a requesting user’s membership or subscription tier.

The present disclosure includes disclosure of a computer-implemented method of operating an online auction platform, wherein the server generates a notification to a subscribing member when a release time for the first auction listing becomes available for that member’s tier.

The present disclosure includes disclosure of a computer-implemented method of operating an online auction platform, wherein the server logs listing visibility events and purchase activity by membership or subscription tier for performance analytics.

The present disclosure includes disclosure of a computer-implemented method of operating an online auction platform, wherein the membership or subscription statuses of the users comprise tier levels stored in a membership database (such as a subscription management module), each tier level being associated with a respective release time delay, and wherein the server automatically delays display of the first auction listing to users of lower-tier membership or subscription levels until expiration of the release time delay applicable to those tiers.

The present disclosure includes disclosure of a computer-implemented method of operating an online auction platform, comprising receiving, by a network-connected server, a first auction listing for a product including a direct purchase price, assigning, by the server, a timestamp to the first auction listing, and automatically displaying, by the server executing an access-control algorithm, the first auction listing to users of the online auction platform based on their membership or subscription status and a comparison between the timestamp and a current server time, thereby enabling subscribing members to view and purchase the listing prior to non-subscribing members.

The present disclosure includes disclosure of a computer-implemented method of operating an online auction platform, wherein the online auction platform is hosted on and operated using a server, wherein the steps of receiving, assigning, and automatically displaying are performed using one or more algorithms accessible by said server, and wherein the step of automatically displaying is performed to selectively display the first auction listing on a screen of an electronic device.

The present disclosure includes disclosure of a computer-implemented method of operating an online auction platform, wherein the server compares the timestamp to a current server time and delays display to non-subscribing users by a time period associated with a membership or subscription tier.

The present disclosure includes disclosure of a computer-implemented method of operating an online auction platform, wherein the first auction listing is displayed to a member user a) after comparing the timestamp to a current server time, and b) after determining that the membership or subscription status of the member user is that of a subscribing member user.

The present disclosure includes disclosure of a computer-implemented method of operating an online auction platform, wherein the first auction listing is not displayed to a member user a) after comparing the timestamp to a current server time, and b) after determining that the membership or subscription status of the member user is not that of a subscribing member user, until after a specified period of time, the specified period of time determined by comparing the timestamp to the current server time.

The present disclosure includes disclosure of a computer-implemented method of operating an online auction platform, wherein the first auction listing is displayed to a member user after determining that the membership or subscription status of the member user is that of a subscribing member user and after a query by the subscribing member user is associated with the first auction listing.

The present disclosure includes disclosure of a computer-implemented method of operating an online auction platform, wherein when the membership or subscription status of a particular member user identifies that the particular member user is not a subscribing member user, the first auction listing is not available to the non-subscribing member until after a specified period of time, the specified period of time determined by comparing the timestamp to the current server time.

The present disclosure includes disclosure of a computer-implemented method of operating an online auction platform, wherein the step of automatically displaying is performed to display the first auction listing to the subscribing member user after the subscribing member user is logged in with the online auction platform.

The present disclosure includes disclosure of a computer-implemented method of operating an online auction platform, wherein the step of automatically displaying is performed to display the first auction listing to a non-subscribing member user after the non-subscribing member user is logged in with the online auction platform, wherein the first auction is selectively displayed to the non-subscribing member user only after a specified period of time, the specified period of time determined by comparing the timestamp to the current server time.

The present disclosure includes disclosure of a computer-implemented method of operating an online auction platform, wherein the membership or subscription statuses of said users are determined by determining which users are subscribing member users.

The present disclosure includes disclosure of a computer-implemented method of operating an online auction platform, wherein a user of the online auction platform can become a subscribing member user of the online platform after paying a fee associated with a subscription to become a subscribing member.

The present disclosure includes disclosure of a computer-implemented method of operating an online auction platform, wherein determining the membership or subscription status of a user comprises verifying, by the server, that the user has paid an active subscription fee recorded in a membership database (such as a subscription management module), and wherein access to the first auction listing is granted only after confirmation of the paid subscription status.

The present disclosure includes disclosure of a computer-implemented method of operating an online auction platform, wherein a subscribing member user of the online auction platform can view the displayed first auction listing and purchase the product in connection with said first auction listing before non-subscribing member users of the online platform can display the first auction listing.

The present disclosure includes disclosure of a computer-implemented method of operating an online auction platform, wherein the membership or subscription statuses of the users comprise tier levels stored in a membership database (such as a subscription management module), each tier level being associated with a respective release time delay, and wherein the server automatically delays display of the first auction listing to users of lower-tier membership or subscription levels until expiration of the release time delay applicable to those tier.

The present disclosure includes disclosure of a computer-implemented method of operating an online auction platform, comprising receiving, by a network-connected server, a first auction listing for a product including a direct purchase price, assigning, by the server, a timestamp to the first auction listing, and automatically displaying, by the server executing an access-control algorithm, the first auction listing to users of the online auction platform based on their membership or subscription status and a comparison between the timestamp and a current server time, thereby enabling subscribing members to view and purchase the listing prior to non-subscribing members, wherein the online auction platform is hosted on and operated using a server, wherein the steps of receiving, assigning, and automatically displaying are performed using one or more algorithms accessible by said server, wherein the step of automatically displaying is performed to selectively display the first auction listing on a screen of an electronic device, and wherein a subscribing member user of the online auction platform can view the displayed first auction listing and purchase the product in connection with said first auction listing before non-subscribing member users of the online platform can display the first auction listing.

The present disclosure includes disclosure of a computer-implemented method of operating an online auction platform, wherein the access-control algorithm improves computational efficiency by distributing listing query execution across membership or subscription tiers to reduce concurrent database load.

The present disclosure includes disclosure of a computer-implemented method of operating an online auction platform, wherein the first auction listing is not displayed to a non-subscribing member user until after a specified period of time, the specified period of time determined by comparing the timestamp to the current server time.

The present disclosure includes disclosure of a computer-implemented method of operating an online auction platform, wherein the first auction listing is displayed to a member user a) after comparing the timestamp to a current server time, and b) after determining that the membership or subscription status of the member user is that of a subscribing member user.

The present disclosure includes disclosure of a computer-implemented method of operating an online auction platform, wherein the first auction listing is not displayed to a member user a) after comparing the timestamp to a current server time, and b) after determining that the membership or subscription status of the member user is not that of a subscribing member user, until after a specified period of time, the specified period of time determined by comparing the timestamp to the current server time.

The present disclosure includes disclosure of a computer-implemented method of operating an online auction platform, wherein the first auction listing is displayed to a member user after determining that the membership or subscription status of the member user is that of a subscribing member user.

The present disclosure includes disclosure of a computer-implemented method of operating an online auction platform, comprising receiving, by a network-connected server, a first auction listing for a product including a direct purchase price, assigning, by the server, a timestamp to the first auction listing, determining, by the server, a release time for the first auction listing based on membership-tier data, automatically filtering, by an access-control algorithm executed on the server, listings that have not reached the release time for a requesting user’s membership or subscription tier, and dynamically adjusting, by the server, the release time based on detected network load, listing engagement, or predicted access demand for each membership or subscription tier, thereby improving performance and user experience through adaptive control of listing visibility.

The present disclosure includes disclosure of a system for operating an online auction platform, comprising a network-connected server, a listings database or module configured to store auction listings and associated timestamps, a membership database (such as a subscription management module) configured to store user account data including membership or subscription status and release-time parameters, and an access-control module executed by the server and configured to receive an auction listing for a product including a direct purchase price, assign a timestamp to the auction listing, determine, for each user, a release time for the auction listing based on the user’s membership or subscription status, compare a current server time to the release time, and transmit, to a client device of the user, a filtered result set of listings that excludes listings whose release time has not yet elapsed for that user’s membership or subscription tier, thereby enabling subscribing members to view and purchase listings prior to non-subscribing members.

The present disclosure includes disclosure of a system for operating an online auction platform, wherein the access-control module filters listings prior to execution of a search query by excluding listings having release times later than the current server time for a given membership or subscription tier.

The present disclosure includes disclosure of a system for operating an online auction platform, wherein the membership database (such as a subscription management module) further stores tier-level data, each tier being associated with a respective release time delay, and wherein the access-control module automatically delays display of auction listings to users of lower-tier membership or subscription levels until expiration of the release time delay applicable to those tiers.

The present disclosure includes disclosure of a system for operating an online auction platform, wherein the access-control module dynamically adjusts release-time parameters based on detected network load or listing popularity metrics.

The present disclosure includes disclosure of a system for operating an online auction platform, wherein the server executes authentication logic requiring a user login prior to providing access to any auction listing.

The present disclosure includes disclosure of a system for operating an online auction platform, wherein the server verifies, via the membership database (such as a subscription management module), that a user has paid an active subscription fee prior to granting access to the auction listings.

The present disclosure includes disclosure of a system for operating an online auction platform, wherein the access-control module generates a notification to a subscribed user when a release time for an auction listing becomes available for that user’s membership or subscription tier.

The present disclosure includes disclosure of a system for operating an online auction platform, wherein the access-control module logs visibility and purchase events for analytics regarding membership-tier engagement and server performance.

The present disclosure includes disclosure of a system for operating an online auction platform, wherein the server distributes query execution across membership or subscription tiers to reduce concurrent database load and improve computational efficiency.

The present disclosure includes disclosure of a system for operating an online auction platform, wherein the server comprises a distributed computing environment including multiple coordinated network-connected servers that collectively enforce tier-based access control to the listings database or module.

The present disclosure includes disclosure of a non-transitory computer-readable medium storing instructions that, when executed by one or more processors of a network-connected server, cause the server to perform a method of operating an online auction platform, the method comprising receiving a first auction listing for a product including a direct purchase price, assigning a timestamp to the first auction listing, determining a release time for the first auction listing based on membership-tier data stored in a membership database (such as a subscription management module), automatically filtering, by an access-control algorithm executed on the server, listings that have not reached the release time for a requesting user’s membership or subscription tier, and transmitting, by the server, a filtered result set for display on a client device, thereby enabling subscribing members to view and purchase listings prior to non-subscribing members.

The present disclosure includes disclosure of a non-transitory computer-readable medium storing instructions that, when executed by one or more processors of a network-connected server, cause the server to perform a method of operating an online auction platform, wherein the instructions further cause the server to filter listings prior to execution of a search query by excluding listings having release times later than the current server time for a given membership or subscription tier.

The present disclosure includes disclosure of a non-transitory computer-readable medium storing instructions that, when executed by one or more processors of a network-connected server, cause the server to perform a method of operating an online auction platform,, wherein the instructions further cause the server to dynamically adjust release times based on detected network load or listing popularity metrics.

The present disclosure includes disclosure of a non-transitory computer-readable medium storing instructions that, when executed by one or more processors of a network-connected server, cause the server to perform a method of operating an online auction platform, wherein the instructions further cause the server to verify that a user has paid an active subscription fee recorded in a membership database (such as a subscription management module) prior to granting access to the first auction listing.

The present disclosure includes disclosure of a non-transitory computer-readable medium storing instructions that, when executed by one or more processors of a network-connected server, cause the server to perform a method of operating an online auction platform, wherein the instructions further cause the server to generate a notification to a subscribed user when a release time for the first auction listing becomes available for that user’s membership or subscription tier.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a diagram of a network used to operably allow servers and users to interact, according to at least one embodiment of the present disclosure;

FIG. 2 shows a diagram of modules stored within an accessible by a server, according to at least one embodiment of the present disclosure;

FIG. 3 shows a diagram of hardware components of a server, according to at least one embodiment of the present disclosure;

FIG. 4 shows a flowchart of a process or method, according to at least one embodiment of the present disclosure;

FIG. 5 shows a flowchart of a process or method, according to at least one embodiment of the present disclosure; and

FIG. 6 shows a flowchart of a process or method, according to at least one embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a method of facilitating sales in an auction sale platform.

In at least one embodiment, the auction sale platform (platform or system 100) operates in connection with a membership or subscription mechanism (a subscription management module 204), whereby a prospective buyer who is a member or a subscriber, such as a paid member or paid subscriber of system 100, would have access to “buy-it-now” (direct purchase) auction listings earlier than those prospective buyers who are not paid members or subscribers.

In an exemplary embodiment, the auction sale platform (system 100) offers membership(s) or subscription(s) to its prospective buyers, such as by way of charging a membership or subscription fee to provide said prospective buyers with the opportunity to access certain auction listings earlier than those prospective buyers who are not paid members or subscribers. It is noted that the most popular online auction platform, eBay, does not currently have a feature granting early access to listings for paying/subscribing buyers.

For example, a seller may list a product for sale on an online auction platform (system 100) at 10:00am on a Monday, effectively creating a product listing. That product listing could include a starting price (such as $20.00, for example), an optional reserve (such as $30.00, for example), and a buy-it-now or outright purchase price (such as $50.00, for example). The online auction sale platform (system 100) may be able to have such listing be immediately available for public viewing, such as at 10:00am on that Monday or at a time soon thereafter or as may be scheduled by the seller. In such a situation, for example, prospective buyers who are paid members or subscribers of the online auction platform (system 100) would have access to said product listing at 10:00am on that Monday (or soon thereafter or as scheduled by the seller), while prospective buyers who are not paid members or subscribers would not have access to said product listing at 10:00am on that Monday (or soon thereafter or as scheduled by the seller). They would instead have access to said product listing a specified time after 10:00am on that Monday (or soon thereafter), such as 1, 2, 3, 4, 5, 10, 15, 20, 30, 45, or 60 minutes later, for example, or less time or a longer time later, such as 45 seconds, 1.5 minutes, 6 minutes, 8 minutes, 12 minutes, or 75 minutes later, for example. The purpose here would be to provide paid members or subscribers with the ability to search for and identify the product listings earlier than the general public (non-paying members or subscribers), and have an opportunity to purchase the items from the product listings through the “buy-it-now” (direct purchase) mechanism sooner than the general public. This would provide an incentive for prospective buyers to become paid members or subscribers of the auction sale platform (system 100) because they would be able to search for and identify potential “deals” before those users 106 who are not paid members or subscribers. This also enhances the user experience by allowing members to purchase high-demand items before they are available to non-members or non-subscribers. This would also increase user engagement, promote brand loyalty, and generate additional revenue to the auction sale platform (system 100).

For sake of completeness, the concept of a paid member or paid subscriber extends to any concept of a prospective buyer of an auction sale platform (system 100) to pay some sort of amount, or provide some other sort of consideration, directly or indirectly to the auction sale platform (system 100), so that said paid member would have access to at least some auction listings prior to those prospective buyers who did not pay some sort of amount, or provide some other sort of consideration, directly or indirectly to the auction sale platform (system 100). For example, a user 106 could be a credit card holder for a particular auction company, with a perk including a membership or subscription permitting early access to listings. Alternatively, a user 106 could pay a membership or subscription fee to have early access to listings as referenced herein.

For example, and in the case of eBay being the online auction platform, eBay could offer the ability to become a paid member or paid subscriber under an “eBay+” or “eBay Plus” or “eBay Premium” moniker, or something similar. Such a moniker could then be used as a marketing tool by eBay (or whoever the online auction platform may be) to increase revenues and potentially increase profitability of the online auction platform.

In at least some embodiments, subscription or membership tiers or levels could be offered, such as Basic, Premium, and Elite tiers or levels, for example. Said tiers or levels could offer differing access, such as 5 minute early access, 10 minute early access, 15 minute early access, 30 minute early access, or shorter or longer access periods, with the higher tiers or levels providing earlier access to said buy-it-now (direct purchase) listings than the lower tiers or levels. Membership or subscriber fees could be paid on a daily, weekly, monthly, or annual basis, or on a shorter or longer time period basis.

Members or subscribers could receive alerts, such as email, text, or smart device application alerts, as to new buy-it-now (direct purchase) listings that meet certain keyword criteria. This would allow the member or subscriber to prepare for a potential purchase of said items.

In various embodiments, the online auction platform (system 100, accessible via website, smart device application, etc.) could have a subscriber or member section that features exclusive buy-it-now (direct purchase) listings as well as a potential countdown timer for upcoming listings.

Using algorithms, the online auction platform (system 100) could also suggest items based on user 106 preferences, keywords, purchase histories, etc., enhancing the overall shopping experience. Security protocols could be put in place to prevent automated systems (“bots”) from exploiting early-access opportunities, ensuring “fair play” among genuine members or subscribers.

In at least some embodiments, the online auction platform (system 100) may already have a basic membership or subscriber mechanism in place to access the platform (system 100) and bid on and purchase items. In such an embodiment, the online auction platform (system 100) would implement an additional level or tier of membership or subscription, costing an additional amount of money, to access early auctions, including “buy-it-now” (direct purchase) items on the auction platform (system 100), as referenced herein.

Such a mechanism differs from Amazon.com “Deals of the Day” or “Lightning Deals,” as potentially applicable to Amazon Prime members. While only Amazon Prime members may have access to certain deals on Amazon.com, said deals are not offered in connection with an online auction platform (system 100) whereby there is an opening auction price and a buy-it-now (direct purchase) price, and said deals are provided for quantities of items greater than one. For example, Amazon may offer a “Lightning Deal” to Amazon Prime members to purchase a 42” HDTV, but there may be hundreds or thousands in stock, allowing for potentially hundreds or thousands of orders to be made. This greatly differs from a situation where a seller on an online auction platform (system 100) has one particular item to sell at a particular price. Furthermore, the Amazon deals are advertised to the prospective buyers before the buyers may be able to purchase the items in the deals, whereas the listings in the online auction platform (system 100) would be available to paid members or paid subscribers only when they are available for purchase.

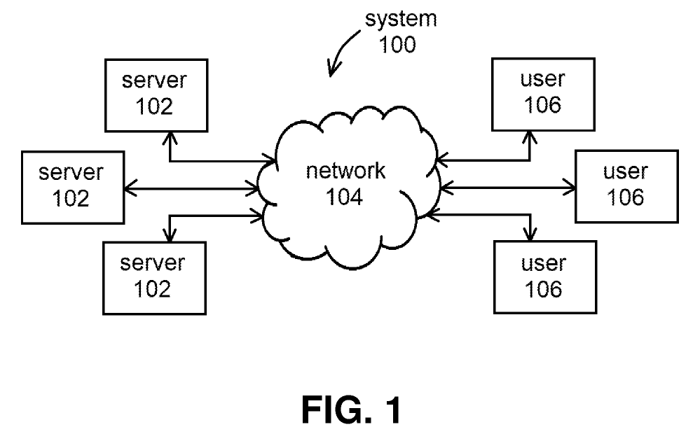

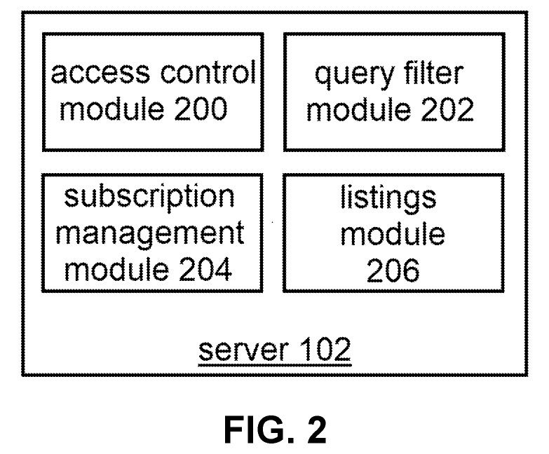

The online auction platforms (systems 100) of the present disclosure can include a network-connected server 102 system executing auction management software, such as shown in FIGS. 1-3. FIG. 1 shows a diagram of servers 102, each having access to a network 104, whereby a plurality of users 106 also have access to the same network 104 so that information from servers 102, such as information from the various modules shown in FIG. 2, is accessible by said users 106. The servers 102 can, for example, maintain a listings database (a listings module 206) storing item details, timestamps (recorded times), and associated membership access parameters. A membership database (subscription management module 204) can store user 106 account information, including payment status, membership or subscription tier (e.g., Basic, Premium, Elite), and access delay parameters corresponding to each tier.

In one implementation, the platform (system 100) can include an access control module 200 executing a time-indexed access algorithm. The module 200 can compute a release time of a particular listing for each user 106 based on membership or subscription tier and compare the current server 102 time to the release threshold (or otherwise utilize a time delay parameter in view of the listing post time) before returning search results or listings. Listings can be temporarily omitted from query results until the current time exceeds the user’s 106 release time parameter. This operation can occur automatically through a database query filter module 202, not through manual selection or sorting. Thus, listing access can be technically restricted by the system’s 100 software architecture, not by voluntary user 106 actions or marketing rules.

When a seller creates a new listing at a posting time T₀, for example, the server 102 can assign an access window during which the listing is visible only to paid members. For example, Premium members may see the listing immediately at T₀, or soon thereafter. Basic members may see it after a five-minute delay (or different time frame or time), and non-members may see it after ten or more minutes (or different time frame or time). If there is only one level of subscribing membership, then the new listing can be available to anyone with that level of subscribing membership at any time, with the time delay only applicable to non-subscribing member users 106. The system 100 can enforce this via query logic that filters listings based on both current time and user 106 tier. When a user 106 searches or browses listings, the server 102 can return only those listings whose access window has expired for that user’s 106 tier, or in the case of only one tier of subscribing member, the server 102 can return all listings at any time.

Unlike the prior art, the disclosed systems 100 and methods can optimize database load and reduce simultaneous access contention by tiered query execution timing. The disclosed methods improve the operation of computer networks by reducing server 102 query contention and database locking frequency when new listings are published. By offsetting listing visibility by tier, the system distributes query load and reduces simultaneous data fetch events, thus improving throughput and latency compared to conventional auction systems.

The platform (system 100) can include a subscription management module 204 to handle fee collection, renewals, and tier upgrades. The auction software (listings module 206 or other software) may generate alerts - via email, text, or mobile notifications - when new listings meeting the user’s 106 criteria become available. Anti-automation security protocols such as CAPTCHA, rate limiting, and authentication tokens are applied to prevent non-human agents from exploiting early access privileges.

The described mechanisms differ from existing systems in that they introduce automated, time-based gating of listing visibility tied to verified membership or subscription levels within a single-instance auction environment. This contrasts with retail or bulk-sale platforms that offer early access to multiple-item sales. The disclosed methods therefore create a novel and non-obvious improvement to online auction functionality.

It is noted that the present disclosure can utilize a time-delayed access logic using membership metadata and server 102 query filtering in a single-instance auction environment, such as referenced above. It is noted that the concepts of auction and per-tier timed visibility and automated query control is not taught or disclosed by the prior art as of the time of the present disclosure. Servers 102 used in the present disclosure can execute an automated query-filtering module 202 that dynamically excludes listings whose access timers have not expired for a given user 106 tier. This filtering can occur prior to result aggregation and ranking, and requires no manual user 106 input or seller configuration.

The server 102 can execute a query-processing pipeline comprising: (i) authentication of user 106 identity and membership or subscription tier; (ii) retrieval of listings metadata including tier-release timestamps; (iii) comparison of current server 102 time against the release timestamp; and (iv) exclusion of listings not yet released for that tier from the returned query results, in at least one embodiment.

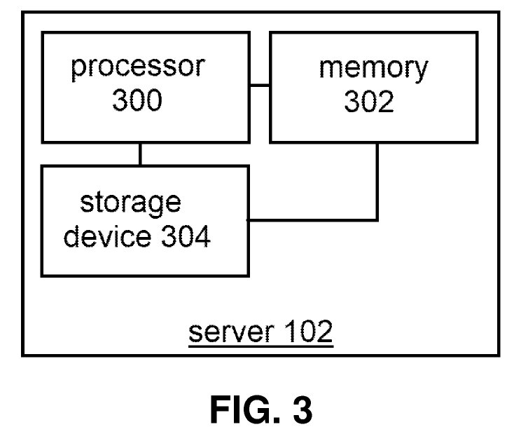

For sake of completion, see FIG. 3, which shows a diagram of components of a server 102, such as a processor 300 configured to access software from a storage device 304 using memory 302, such as, for example, to run the online auction software, including but not limited to the various modules shown in FIG. 2.

The present disclosure describes a smarter kind of online auction platform (system 100); think of it as “eBay with intelligent early-access controls.” It allows sellers to post auction listings as usual, but not everyone gets to see new listings at the same time. Instead, the platform (system 100) uses software logic on the server 102 to decide when each user 106 can view a newly posted item based on their membership or subscription level.

For example, “Premium” members might see new listings right away, “Basic” members see them a few minutes later, while non-members might have to wait even longer. This time-based visibility window is handled automatically by the system 100 - not by humans or marketing rules.

Technically speaking, and in at least one embodiment:

1. A seller posts a listing. The server 102 records the post time and stores it with item details in a listings database or module 206.

2. Membership or subscription data is stored separately in a membership database (such as a subscription management module 204) that keeps track of user 106 tiers and membership or subscription payment status.

3. An access control module 200 on the server 102 runs a time-indexing algorithm that calculates the earliest time each membership or subscription level can view the listing should there be multiple levels of membership or subscription. If there is only one level of subscribing membership, the access control module 200 can permit access to all listings to users 106 at that subscribing membership at any time.

4. When a user 106 searches or browses listings, the system 100 checks the user’s 106 tier or membership or subscription level, compares the current time to their tier’s access time, and filters out any listings that are still restricted.

5. Listings can become visible in waves, such as to “Premium” users 106 first, then lower tiers later, to reward members, reduce server 102 load, and improve performance.

In at least one embodiment, subscribing members have access to all listings at all times, and non-subscribing members only have access after a predetermined period of time, such as by comparing the timestamp to a then-current server 102 time.

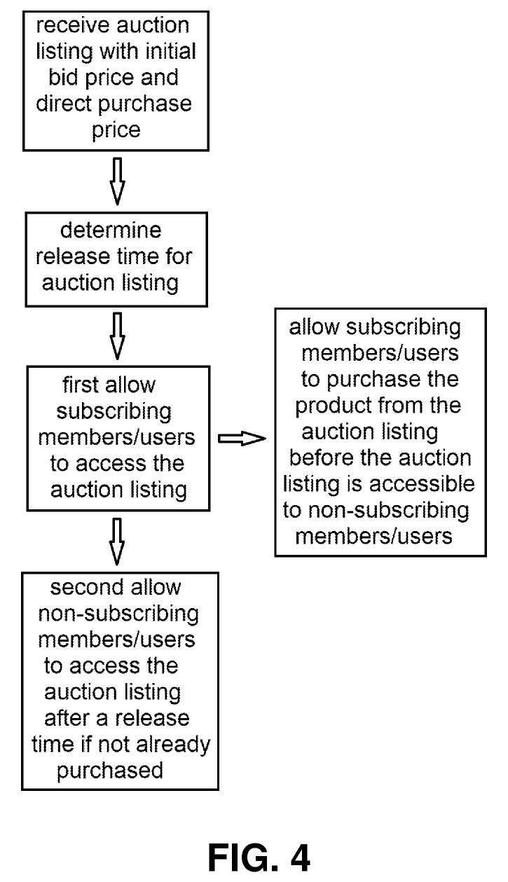

One exemplary process/method is depicted in flowchart format in FIG. 4. As shown therein, a seller can make a new auction listing for a product having an initial bid price and a purchase price. Once listed, system 100 can determine a release time (or release times) for the auction listing depending on membership or subscription level, with subscribing members/users 106 having access to the auction listing prior to non-subscribing members/users 106. Subscribing members/users 106 can then access and potentially purchase the product from the auction listing before the auction listing is even available or accessible to non-subscribing members/users 106. Should the release time elapse without the product being purchased by a subscribing member/user 106, the auction listing would be made available to non-subscribing members/users 106 at or after the release time has elapsed.

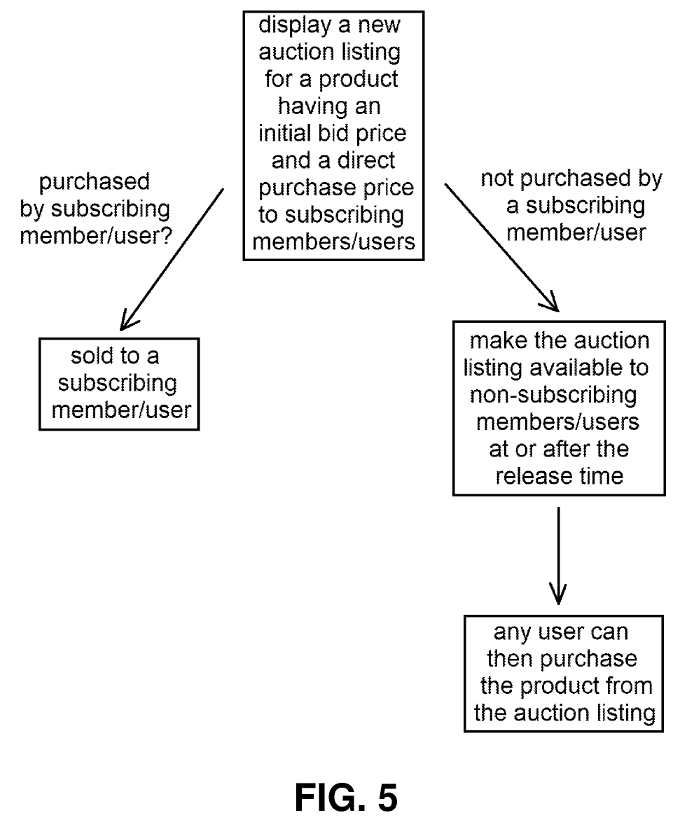

Another exemplary process/method is depicted in flowchart format in FIG. 5. As shown therein, the system 100 can display a new auction listing for a product having an initial bid price and a direct purchase price to subscribing members/users 106. If the product is purchased by a subscribing member/user 106, it is sold to said subscribing member/user 106. If the product is not purchased by a subscribing member/user 106, after a certain time period has elapsed (such as the release time), the auction listing can be made available to non-subscribing members/users 106, and any user 106 can then purchase the product from the auction listing.

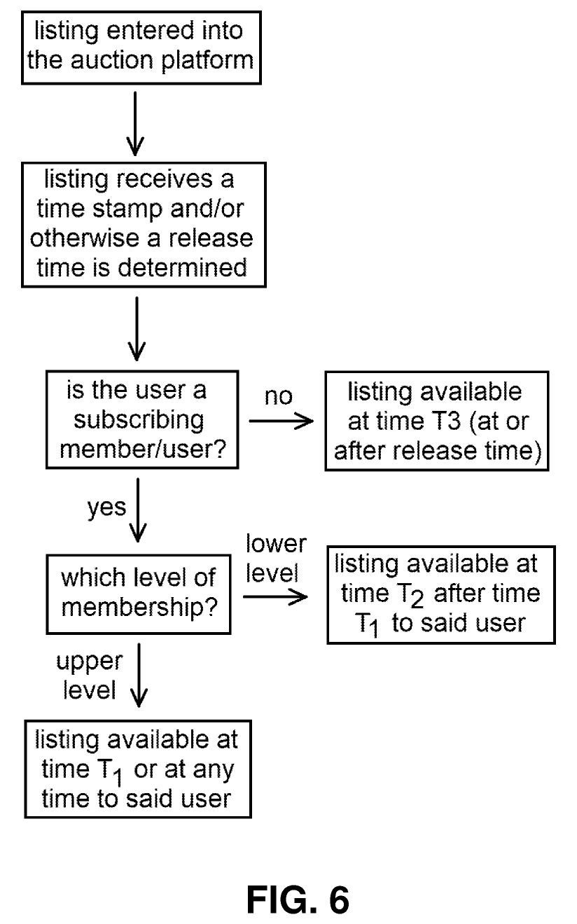

Another exemplary process/method is depicted in flowchart format in FIG. 6. As shown therein, an auction listing can be entered into the auction platform (system 100), the auction listing having an opening bid price and a direct purchase price. The listing can receive a time stamp and/or otherwise a release time for the listing can be determined. If the user 106 is a subscribing member/user 106, and if there are multiple levels of membership or subscription, then the upper level of membership or subscription would have the earliest access to the listing, such as at time T₁, and the lower level of membership or subscription would have the next access to the listing, such as at time T₂ after time T₁ but before non-subscribing members/users 106 would have access. If the user 106 is not a subscribing member/user 106, then that user 106 would only have access to the listing at a time T₃, after time T₁ and time T₂, and only at or after the release time.

This is an improvement over current systems, as current auction or retail systems like eBay, Amazon, or Ticketmaster don’t operate this way. For example, eBay releases all listings at once with no tiered visibility. Amazon Prime offers early access to bulk sales, not one-of-a-kind auctions. Ticketmaster and Nike SNKRS use waiting lines, not automated access control. The present systems and methods combine real-time auction management with algorithmic access gating tied to verified memberships or subscriptions, improving both performance and monetization.

While various embodiments of systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A method of operating an online auction platform, comprising the steps of:
receiving an auction listing listed at a recorded time for a product including an initial auction bid price and a direct purchase price;
determining, by one or more network-connected servers, a release time for the auction listing for non-subscribing users based on the recorded time and a time delay parameter; and
first displaying the auction listing to a subscribing user of the online auction platform prior to the auction listing being available to a non-subscribing user of the online auction platform;
wherein providing access to the auction listing to the non-subscribing user comprises, prior to transmitting query results to a user device, executing a server-side query filter that excludes auction listings whose release time for the non-subscribing user has not yet expired.

2. The method of claim 1, further comprising the step of:
second displaying the auction listing to a non-subscribing user of the online auction platform at or after the release time.

3. The method of claim 2, wherein the steps of receiving, first displaying, and second displaying are performed using the one or more network-connected servers.

4. The method of claim 1, further comprising the step of:
comparing the recorded time to a then-current server time to determine whether or not a user of the online auction platform has access to the auction listing at the then-current server time, said step of comparing performed prior to the step of first displaying.

5. The method of claim 1, wherein the subscribing user has access to the auction listing and any other auction listing within the online auction platform at any time, and wherein a non-subscribing user has access to the auction listing after the subscribing user.

6. The method of claim 1, wherein the subscribing user has a membership tier associated therewith, the membership tier selected from a first membership level and a second membership level different than the first membership level.

7. The method of claim 6, wherein the first membership level provides the subscribing user with earlier access to the auction listing than the second membership level would provide.

8. The method of claim 1, wherein the step of first displaying is performed to display the auction listing on a screen of an electronic device.

9. The method of claim 1, wherein the auction listing is displayed to the subscribing user after determining that a membership status identifies the subscribing user as a subscribing user.

10. The method of claim 1, wherein the auction listing is displayed to a subscribing user after the subscribing user is authenticated by logging into the online auction platform.

11. The method of claim 1, wherein the auction listing is only displayed to a non-subscribing user after the non-subscribing user is logged into the online auction platform and only on or after the release time.

12. The method of claim 1, wherein a user of the online auction platform becomes a subscribing user after payment of a fee associated with a subscription to the online auction platform.

13. The method of claim 1, wherein a subscribing user of the online auction platform can view the auction listing and purchase the product associated with the auction listing before non-subscribing users of the online auction platform can view the auction listing.

14. The method of claim 1, wherein membership statuses of users of the online auction platform comprise tier levels stored in a membership database, each tier level being associated with a respective release time delay, and wherein the server automatically delays display of the auction listing to users of lower-tier membership levels until expiration of the release time delay applicable to those tiers.

15. The method of claim 3, wherein the one or more network-connected servers are configured to execute an access-control algorithm that improves computational efficiency by distributing listing query execution across membership tiers to reduce concurrent database load.

16. A computer-implemented method of operating an online auction platform, comprising the steps of:
receiving an auction listing listed at a recorded time for a product including an initial auction bid price and a direct purchase price;
first displaying the auction listing to a subscribing user of the online auction platform prior to the auction listing being available to a non-subscribing user of the online auction platform; and
second displaying the auction listing to the non-subscribing user of the online auction platform after a predetermined time has elapsed between the recorded time and a then-current server time;
wherein each step is performed using one or more network-connected servers.

17. The method of claim 16, wherein the subscribing user has a membership tier associated therewith, the membership tier selected from a first membership level and a second membership level different than the first membership level.

18. The method of claim 17, wherein the first membership level provides the subscribing user with earlier access to the auction listing than the second membership level would provide.

19. The method of claim 17, wherein the auction listing is only displayed to a non-subscribing user after the non-subscribing user is logged into the online auction platform and only after the predetermined time has elapsed between the recorded time and a then-current server time.

20. The method of claim 17, wherein a subscribing user of the online auction platform can view the auction listing and purchase the product associated with the auction listing before non-subscribing users of the online auction platform can view the auction listing.
